(19) United States
(12) Patent Application Publication
(10) Pub. No.: US 2026/0315910 A1
(43) Pub. Date: Oct. 15, 2026

(54) ONE OR MORE COMPUTER-READABLE STORAGE MEDIA, GAME SYSTEM, AND COMPUTER-IMPLEMENTED METHOD

(71) Applicant: NINTENDO CO., LTD., Kyoto (JP)

(72) Inventors: Toshiaki SUZUKI, Kyoto (JP); Osamu TSUCHIHASHI, Tokyo (JP)

(21) Appl. No.: 19/640,828

(22) Filed: Apr. 7, 2026

Related U.S. Application Data
(63) Continuation of application No. PCT/JP2023/037076, filed on Oct. 12, 2023.

(51) Int. Cl. A63F 13/211; A63F 13/837

(52) U.S. Cl. CPC A63F 13/211; A63F 13/837

(57) ABSTRACT

A game program capable of performing a novel game using a mouse that can be moved on a work surface is provided. An example of a game system includes a mouse that can be moved on a work surface. When the mouse is moved on the work surface, a first object is moved. When a predetermined operation is performed when the mouse is on the work surface, processing of causing an action based on a position of the first object in a virtual space to occur and decreasing a parameter is performed. When the mouse is lifted from the work surface, processing of increasing the parameter is performed.

### CROSS REFERENCE TO RELATED APPLICATION

This application is a continuation of International Patent Application No. PCT/JP2023/037076 filed on Oct. 12, 2023, the entire contents of which is incorporated herein by reference.

### FIELD

The technique shown here relates to a game program, a game system, and a game processing method that allow a game to be played using a mouse.

### BACKGROUND AND SUMMARY

Conventionally, there is a game in which a game operation is performed by moving a mouse on a work surface.

However, there has been room for improvement in order to play various games using a mouse.

An exemplary embodiment discloses a game program, a game system, and a game processing method that allow a novel game using a mouse to be played.

An exemplary embodiment adopts the following configurations.

### First Configuration

A game program of a first configuration causes a computer to execute a first process of moving a first object in a virtual space based on first data output in response to movement of a mouse on a work surface. Also, the game program causes the computer to execute, when the mouse is on the work surface, a second process including occurrence of an action regarding the first object and a decrease in a first parameter. Also, the game program causes the computer to execute a third process of increasing the first parameter based on second data output in response to the mouse being lifted from the work surface.

According to the above, the first parameter can be decreased when the mouse is operated on the work surface, and the first parameter can be increased when the mouse is lifted from the work surface, and a novel game can be played using the mouse.

### Second Configuration

In the second configuration, in the first configuration, in the third process, the first parameter may be increased based on third data output in response to the mouse being lifted from the work surface and a first operation being performed on the mouse.

According to the above, the first parameter can be increased when the first operation is performed together with the operation of lifting the mouse. Thereby, for example, the first parameter can be increased by further reflecting a user's intention.

### Third Configuration

In the third configuration, in the second configuration, in the second process, the first parameter may be decreased based on fourth data output in response to the mouse being on the work surface and a second operation being performed on the mouse.

According to the above, the first parameter can be decreased when the second operation is performed when the mouse is on the work surface.

### Fourth Configuration

In the fourth configuration, in the third configuration, the second operation may be the same operation as the first operation.

According to the above, the first parameter can be increased or decreased by the same operation when the mouse is on the work surface and when the mouse is lifted from the work surface.

### Fifth Configuration

In the fifth configuration, in any of the second to fourth configurations, the mouse includes an inertial sensor, and the first operation may be an operation in which the inertial sensor outputs a predetermined value.

According to the above, the second process can be performed based on a value output from the inertial sensor when the mouse is lifted, as well as the movement of the mouse on the work surface.

### Sixth Configuration

In the sixth configuration, in the fifth configuration, the predetermined value may be a value indicating that the mouse is being shaken.

According to the above, the second process can be performed by shaking the mouse when the mouse is lifted, and the first parameter can be increased by a simple operation.

### Seventh Configuration

In the seventh configuration, in any of the first to sixth configurations, when the mouse is returned onto the work surface and moved after the mouse has been lifted from the work surface, the first object may be moved from a position where the mouse was lifted from the work surface.

According to the above, when the mouse is moved on the work surface, lifted from the work surface, and returned onto the work surface again, the first object is moved from the position at which the mouse was when the mouse was lifted from the work surface. Thereby, even if the mouse is lifted from the work surface, it is possible not to change the position of the first object.

### Eighth Configuration

In the eighth configuration, in any of the first to seventh configurations, in the second process, the first parameter may be decreased based on fourth data output in response to the mouse being on the work surface and a second operation being performed on the mouse. The game program may cause the computer to execute a fourth process different from increase or decrease of the first parameter based on fifth data output in response to the mouse being lifted from the work surface and the second operation being performed.

According to the above, different processes can be performed in response to the third operation when the mouse is on the work surface and when the mouse is lifted from the work surface.

### Ninth Configuration

In the ninth configuration, in any of the first to eighth configurations, the game program may cause the computer to execute a fourth process different from the second process based on fifth data output in response to the mouse being tilted while being partially in contact with the work surface.

According to the above, different processes can be performed when the mouse is lifted from the work surface and when the mouse is tilted while a part of the mouse is in contact with the work surface.

Further, another configuration may be a game system that executes the above processes, or a game processing method including each of the above processes.

According to an exemplary embodiment, a novel game can be played using a mouse.

### BRIEF DESCRIPTION OF THE DRAWINGS

FIG. 1 shows an exemplary illustrative non-limiting drawing of an example of a configuration of a game system 1.

FIG. 2 shows an exemplary illustrative non-limiting drawing of an example of an external appearance when a mouse 10 is placed on a work surface.

FIG. 3 shows an exemplary illustrative non-limiting drawing of an example of an external appearance when the mouse 10 is viewed from a back side.

FIG. 4 shows an exemplary illustrative non-limiting drawing of a state when the mouse 10 is lifted.

FIG. 5 shows an exemplary illustrative non-limiting drawing of an example of a game image displayed on a screen of a display device when a shooting game is played in the game system 1.

FIG. 6 shows an exemplary illustrative non-limiting drawing of an example of a game image when an aiming object 31 is moved and the aiming object 31 overlaps a position of a target object 33.

FIG. 7 shows an exemplary illustrative non-limiting drawing of an example of a game image when a firing instruction is performed by a user.

FIG. 8 shows an exemplary illustrative non-limiting drawing of an example of a game image when reloading of bullets is performed.

FIG. 9 shows an exemplary illustrative non-limiting drawing of an example of various data used in game processing.

FIG. 10 shows an exemplary illustrative non-limiting drawing of an example of a flowchart of game processing regarding a first game.

FIG. 11 shows an exemplary illustrative non-limiting drawing of an example of a game image of a second game using the mouse 10.

FIG. 12 shows an exemplary illustrative non-limiting drawing of an example of a game image after the mouse 10 is moved on a work surface 150 from the state of FIG. 11.

FIG. 13 shows an exemplary illustrative non-limiting drawing of an example of a game image when the mouse 10 is lifted from the state of FIG. 12.

### DETAILED DESCRIPTION OF NON-LIMITING EXAMPLE EMBODIMENTS

### Configuration of Game System

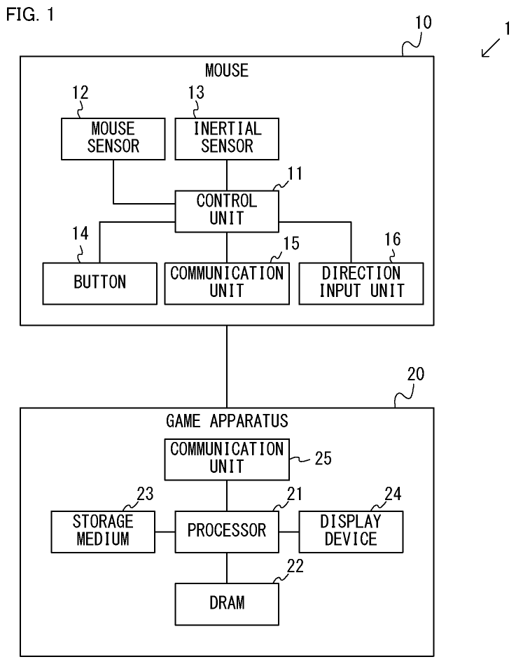

Hereinafter, a game system according to this embodiment will be described. FIG. 1 is a diagram showing an example of a configuration of a game system 1. As shown in FIG. 1, the game system 1 in this example embodiment includes a mouse 10 and a game apparatus 20. The mouse 10 is placed on a work surface such as a desk or a floor, and is moved on the work surface. The mouse 10 includes a sensor for detecting movement on the work surface. Note that the work surface may be a curved surface instead of a flat surface. Also, the work surface does not necessarily have to be a horizontal surface like a desk or a floor surface, and may be tilted with respect to a horizontal plane, or may be a wall surface. The work surface may be a human body surface such as, for example, a leg.

For example, the mouse 10 is used to indicate a position in a virtual space or on a screen of a display device, and has a size that can be held by a user with one hand. The mouse 10 may be an optical mouse using red, blue, or infrared LEDs, or may be a laser mouse. Also, the mouse 10 may be a mechanical mouse. In the following, the mouse 10 is described as a mouse having a light source such as an LED or a laser.

As shown in FIG. 1, the mouse 10 includes a control unit 11, a mouse sensor 12, an inertial sensor 13, a button 14, a communication unit 15, and a direction input unit 16. Also, the mouse 10 has a battery (not shown). The control unit 11 is connected to the mouse sensor 12, the inertial sensor 13, the button 14, the communication unit 15, and the direction input unit 16, and controls the operation of the mouse 10.

The mouse sensor 12 is a sensor for detecting movement on a work surface such as, for example, a desk or a floor. The mouse sensor 12 includes an image sensor, a control circuit, a light source, and a lens. The image sensor outputs an image of the work surface by receiving, via the lens, reflected light of light that the light source has irradiated to the outside. The control circuit calculates movement (movement direction and movement amount) of the mouse 10 on the work surface based on a plurality of images from the image sensor. As the light source, a red or blue LED, an infrared LED, a laser, etc. are used.

The inertial sensor 13 is a sensor for detecting movement and attitude of the mouse 10. As an example, the inertial sensor 13 includes an acceleration sensor and an angular velocity sensor. The acceleration sensor outputs data according to acceleration in each of XYZ axial directions fixed to the mouse 10. The angular velocity sensor outputs data according to angular velocity around each of the XYZ axes. The control unit 11 can calculate the movement and attitude of the mouse 10 based on data from the acceleration sensor and/or the angular velocity sensor. Note that the inertial sensor 13 may include only either one of the acceleration sensor and the angular velocity sensor.

The button 14 includes an operation member to be pressed by a user, and a switch that detects that the operation member is pressed. The mouse 10 includes a plurality of buttons 14 (buttons 14a and 14b to be described later).

The direction input unit 16 is an input unit for inputting a direction. The direction input unit 16 may be an analog stick that inputs a direction by tilting an operation member in an arbitrary direction. Also, the direction input unit 16 may be an analog pad that inputs a direction by sliding an operation member in an arbitrary direction. Also, the direction input unit 16 may be a cross key capable of inputting up, down, left, and right directions.

The communication unit 15 communicates with a communication unit 25 of the game apparatus 20. The communication unit 15 of the mouse 10 and the communication unit 25 of the game apparatus 20 may be connected by wire or may be connected wirelessly. For example, when the mouse 10 is moved on the work surface, the control unit 11 transmits data regarding a movement direction and a movement amount on the work surface from the mouse sensor 12 to the communication unit 15. The communication unit 15 outputs the data regarding the movement direction and the movement amount from the control unit 11 to the communication unit 25 of the game apparatus 20. Also, the control unit 11 calculates the movement and attitude of the mouse 10 based on data from the inertial sensor 13, and transmits data regarding the movement and attitude to the communication unit 15. The communication unit 15 outputs the data regarding the movement and attitude from the control unit 11 to the communication unit 25 of the game apparatus 20. Also, the control unit 11 transmits data according to operations on the button 14 and the direction input unit 16 to the communication unit 15, and the communication unit 15 transmits the data to the communication unit 25 of the game apparatus 20.

Also, the game apparatus 20 includes a processor 21, a DRAM 22, a storage medium 23, a display device 24, and a communication unit 25. The processor 21 is connected to the DRAM 22, the storage medium 23, the display device 24, and the communication unit 25. The processor 21 includes one or more processors. For example, the processor 21 includes one or more CPUs (Central Processing Units) and one or more GPUs (Graphics Processing Units). The CPU performs information processing according to a predetermined program. For example, the CPU executes a game program to be described later. The processor 21 may be configured from an SoC (System-on-a-chip) including one or more CPUs and one or more GPUs.

The DRAM 22 is a memory used to temporarily store various data used in information processing. The processor 21 performs predetermined information processing (for example, game processing to be described later) using the DRAM 22. The storage medium 23 is, for example, a non-volatile memory, and stores various data such as a game program and image data used for a game. The storage medium 23 may be an HDD, an optical disk, etc. Also, the storage medium 23 may be provided inside the game apparatus 20 in advance, or may be detachably connected to the game apparatus 20.

The display device 24 displays an image generated by the GPU of the processor 21. As the display device 24, an arbitrary display device such as a liquid crystal display device or an organic EL display device may be used. Also, a touch panel may be provided on the screen of the display device 24. Also, the game apparatus 20 includes a speaker and a microphone (not shown). Note that the game apparatus 20 may include an output unit for outputting images and sound to an external display device (for example, a television) different from the display device 24. The game apparatus 20 does not have to include the display device 24, the speaker, and the microphone.

The communication unit 25 communicates with the communication unit 15 of the mouse 10 by wire or wirelessly.

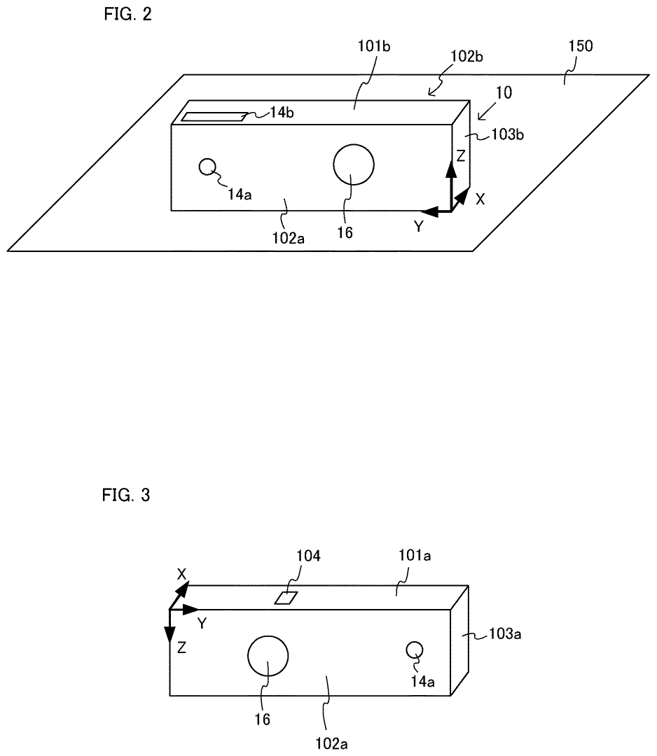

Next, an external appearance of the mouse 10 will be described with reference to FIGS. 2 and 3. FIG. 2 is a diagram showing an example of an external appearance when the mouse 10 is placed on a work surface. FIG. 3 is a diagram showing an example of an external appearance when the mouse 10 is viewed from a back side.

As shown in FIGS. 2 and 3, the mouse 10 has, for example, a substantially rectangular parallelepiped shape. An XYZ orthogonal coordinate system is set for the mouse 10. For example, an X-axis is a right-direction axis of the mouse 10, and a Y-axis is a longitudinal-direction axis. A Z-axis is a height-direction axis, and is an axis perpendicular to the X-axis and the Y-axis.

The mouse 10 includes a bottom surface 101a (XY plane) and an upper surface 101b facing the bottom surface 101a. An opening 104 is provided in the bottom surface 101a of the mouse 10. The opening 104 exposes a lens of the mouse sensor 12 to the outside. Light from the light source that has come out from the opening 104 is reflected on a work surface facing the bottom surface 101a, and the image sensor receives the reflected light.

Also, the mouse 10 includes a left side surface 102a that is a surface substantially perpendicular to the bottom surface 101a and substantially parallel to a YZ plane. A button 14a and a direction input unit 16 are provided on the left side surface 102a. Note that the button 14a may include a plurality of buttons. Also, the button 14a and the direction input unit 16 may be provided on a right side surface 102b facing the left side surface 102a. Also, the mouse 10 includes a front surface 103a substantially parallel to an XZ plane, and a rear surface 103b facing the front surface 103a.

Also, a button 14b is provided on the upper surface 101b of the mouse 10. Note that the button 14b may include a plurality of buttons.

As shown in FIG. 2, the mouse 10 is placed on a work surface 150 such that the bottom surface 101a faces the work surface 150 (that is, such that the upper surface 101b faces upward). When operating the mouse 10 with the right hand, for example, a user places the palm on the upper surface 101b such that the index finger touches the button 14b, and moves the mouse 10 on the work surface 150. The image sensor of the mouse sensor 12 repeatedly takes an image of the work surface at predetermined time intervals. The control circuit of the mouse sensor 12 calculates movement (movement direction and movement amount) of the mouse 10 on the work surface 150 by detecting movement of unevenness on the work surface based on a plurality of images from the image sensor.

Note that the external appearance of the mouse 10 shown in FIGS. 2 and 3 is merely an example, and the mouse 10 may have any shape. For example, the mouse 10 may include a substantially flat bottom surface 101a in which the opening 104 is provided, and an upper surface 101b having a substantially oval shape that is overall rounded and has a shape along the shape of a user's palm. Also, the mouse 10 may have a substantially rectangular parallelepiped shape in which some corners of the rectangular parallelepiped are formed in an R-shape. For example, a connection portion between the upper surface 101b and the front surface 103a may be formed by a curved surface, and the button 14b may be provided across the upper surface 101b and the front surface 103a.

Also, the control unit 11 may calculate movement (movement direction and movement amount) of the mouse 10, instead of the mouse sensor 12 (the control circuit thereof) calculating the movement. Also, the mouse sensor 12 or the control unit 11 may calculate a current position with respect to a certain reference position, in addition to calculating the movement direction and movement amount of the mouse 10 on the work surface (or instead of calculating the movement direction and movement amount). In this case, the mouse 10 transmits the calculated position to the game apparatus 20 in addition to (or instead of) the movement direction and movement amount. Also, an image from the mouse sensor 12 may be transmitted to the game apparatus 20, and the game apparatus 20 may calculate the movement direction and movement amount of the mouse 10 based on the image, and calculate a position indicated by the mouse 10.

Also, the movement and attitude of the mouse 10 may be calculated in the game apparatus 20 instead of the mouse 10. In this case, the mouse 10 transmits data from the inertial sensor 13 to the game apparatus 20, and the game apparatus 20 calculates the movement and attitude of the mouse 10 based on the data.

Also, the attitude of the mouse 10 may be calculated based on data from the mouse sensor 12 instead of data from the inertial sensor 13. For example, when two mouse sensors 12 are provided in the Y-axis direction, it is possible to calculate whether or not the mouse 10 is tilted with respect to the work surface (whether or not it is rotating around the X-axis) based on data from the two mouse sensors 12. For example, if one of the two mouse sensors 12 can obtain an appropriate image and the other cannot obtain an appropriate image, it can be determined that the Y-axis is tilted upward or downward.

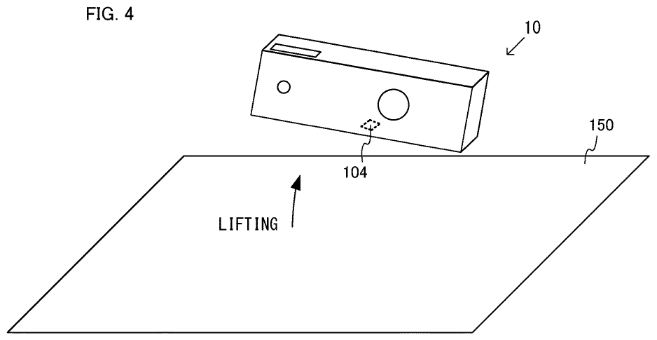

FIG. 4 is a diagram showing a state when the mouse 10 is lifted. As shown in FIG. 4, when the mouse 10 is lifted in a direction away from the work surface 150 (a y-axis direction perpendicular to the work surface) while the mouse 10 is placed on the work surface 150, the image sensor of the mouse sensor 12 becomes unable to receive reflected light of appropriate light intensity and becomes unable to appropriately read an image of the work surface. In this case, the mouse sensor 12 outputs data indicating that an image of the work surface 150 cannot be appropriately read. Alternatively, the mouse sensor 12 may output data indicating a movement amount (a value larger than “0” when moving, “0” when stationary) when on the work surface 150, while outputting data indicating an error when an image of the work surface cannot be appropriately read. Alternatively, the mouse sensor 12 may output data indicating the intensity of reflected light, etc. The game apparatus 20 may determine that the mouse 10 has been lifted by, for example, comparing the intensity of reflected light with a predetermined value. The game apparatus 20 can determine that the mouse 10 has been lifted by receiving such data output when the mouse 10 is being lifted. Here, an operation in which the bottom surface 101a of the mouse 10, in which the mouse sensor 12 (opening 104) is provided, is moved in a direction away from the work surface 150 is referred to as a “lifting operation.”

### Summary of Game

Next, a game of this example embodiment performed using the mouse 10 will be described. A first game of this example embodiment is a shooting game.

FIG. 5 is a diagram showing an example of a game image displayed on a screen of a display device when a shooting game is played in the game system 1. Note that the game image may be displayed on the display device 24 included in the game apparatus 20, or may be displayed on an external display device different from the display device 24.

When the game of this example embodiment is started, a gun object 32, a target object 33, and a virtual camera are arranged in a three-dimensional virtual space (game space). The gun object 32 is arranged on the front side of the screen (a position close to the virtual camera), and the target object 33 is arranged on the back side of the screen (a position away from the virtual camera). In response to a user's firing instruction, a bullet object is fired from the position of the gun object 32.

The aiming object 31 is an object for indicating a position on the screen or a position in the virtual space, and indicates a position where a fired bullet object hits. The aiming object 31 moves according to movement of the mouse 10 on the work surface 150.

The target object 33 is an object indicating a target aimed at by a user. For example, the target object 33 may be a circular target. Also, the target object 33 may be an enemy object. The game of this example embodiment is a shooting game in which a user aims at a moving target object 33 and hits it with a bullet object. For example, the target object 33 moves on the screen, and the user aligns the aiming object 31 with the position of the target object 33 and performs a firing instruction for firing a bullet object. When a bullet object fired in response to the firing instruction hits the target object 33, the user earns points. Alternatively, the game of this example embodiment may be a shooting game in which a user aims at a target object 33 that repeats appearing and disappearing and hits it with a bullet object. For example, during execution of the shooting game, the target object 33 appears at an arbitrary position and disappears when a predetermined time has elapsed. The user aligns the aiming object 31 with the position of the target object 33 and fires a bullet object until the appeared target object 33 disappears.

Also, as shown in FIG. 5, for example, a number-of-bullets display 34 is displayed at the lower left of the screen. The number-of-bullets display 34 indicates the remaining number of bullet objects that the user can fire. In FIG. 5, four images showing bullet objects are displayed as the number-of-bullets display 34, indicating that the remaining number of bullets is “4.”

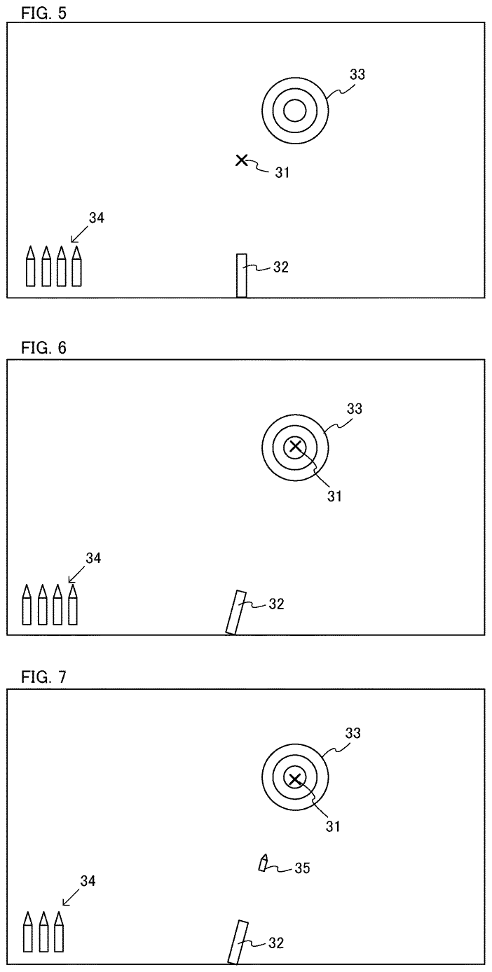

FIG. 6 is a diagram showing an example of a game image when the aiming object 31 is moved and the aiming object 31 overlaps the position of the target object 33. FIG. 7 is a diagram showing an example of a game image when a firing instruction is performed by a user.

As shown in FIG. 6, when a user moves the mouse 10 on the work surface 150, the aiming object 31 moves on the screen. A movement direction and a movement amount of the mouse 10 on the work surface 150 correspond to a movement direction and a movement amount of the aiming object 31 on the screen. For example, according to rightward movement of the mouse 10, the aiming object 31 moves rightward on the screen. According to the position of the aiming object 31, the attitude of the gun object 32 is changed. The position of the gun object 32 may be changed according to the position of the aiming object 31.

When a user performs a firing instruction (for example, pressing the button 14a) using the mouse 10 while the mouse 10 is placed on the work surface 150, a bullet object 35 is fired as shown in FIG. 7. Specifically, the bullet object 35 is fired from the position of the gun object 32 toward the position in the virtual space indicated by the aiming object 31. When the bullet object 35 is fired, the remaining number of bullets indicated by the number-of-bullets display 34 decreases by one and becomes “3.” Further, when the user performs a firing instruction while the mouse 10 is on the work surface 150, a bullet object 35 is fired and the remaining number of bullets indicated by the number-of-bullets display 34 decreases.

When the remaining number of bullets indicated by the number-of-bullets display 34 becomes “0,” a bullet object 35 is not fired even if the user performs a firing instruction while the mouse 10 is on the work surface 150.

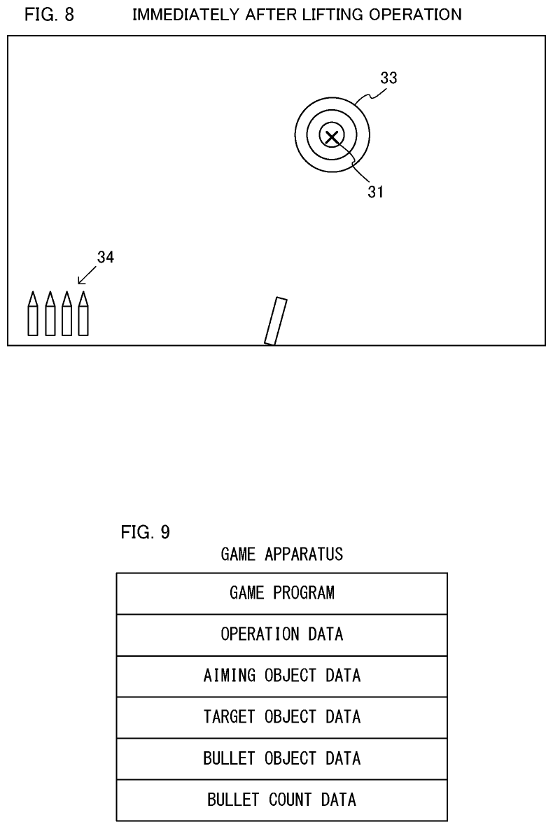

Here, reloading of bullets (increase in the remaining number of bullets) will be described. FIG. 8 is a diagram showing an example of a game image when reloading of bullets is performed.

When a lifting operation is performed on the mouse 10 while the mouse 10 is placed on the work surface 150, bullets are reloaded. When bullets are reloaded, as shown in FIG. 8, the remaining number of bullets indicated by the number-of-bullets display 34 becomes “4,” which is a maximum value. Regardless of what value the remaining number of bullets currently indicated by the number-of-bullets display 34 is, when the lifting operation of the mouse 10 is performed once, the remaining number of bullets indicated by the number-of-bullets display 34 becomes the maximum value.

In a state where the mouse 10 is being lifted, even if a firing instruction is performed, a bullet object 35 is not fired and the remaining number of bullets does not decrease. Also, in a state where the mouse 10 is being lifted, the aiming object 31 remains arranged at the position immediately before the mouse 10 was lifted. Thereafter, when the mouse 10 is placed on the work surface 150 again and moved, the aiming object 31 starts moving from the position immediately before the mouse 10 was lifted.

Note that the aiming object 31 may not be displayed on the screen in a state where the mouse 10 is being lifted. Even in this case, when the mouse 10 is placed on the work surface 150 again and moved, the aiming object 31 may be displayed at the position immediately before the mouse 10 was lifted and moved.

Thereby, even when the mouse 10 is lifted from the work surface 150, the position of the aiming object 31 can be maintained, and it is possible to prevent a user from losing sight of the aiming object 31.

In this way, in the first game of this example embodiment, when the mouse 10 is moved on the work surface 150, data regarding a movement direction and a movement amount is transmitted from the mouse 10 to the game apparatus 20. The game apparatus 20 moves the aiming object 31 based on the data. Also, when the button 14 is pressed while the mouse 10 is on the work surface 150, data indicating that the button 14 has been pressed is output from the mouse 10 together with the data regarding the movement direction and movement amount. The game apparatus 20 fires a bullet object 35 and decreases the remaining number of bullets based on these data output when the mouse 10 is on the work surface 150.

Also, when the mouse 10 is not on the work surface 150, for example, data indicating that an image cannot be appropriately read is output from the mouse 10. The game apparatus 20 determines that the mouse 10 has been lifted based on the data output when the mouse 10 is not on the work surface 150, and increases the remaining number of bullets.

Note that in the above, when the button 14a is pressed while the mouse 10 is on the work surface 150, a bullet object 35 is fired and the remaining number of bullets decreased, and when a lifting operation is performed on the mouse 10, the remaining number of bullets is increased. In another example embodiment, the remaining number of bullets may be increased when a predetermined operation is performed in addition to the lifting operation of the mouse 10. For example, the remaining number of bullets may be increased when the button 14a is pressed while the mouse 10 is being lifted. That is, if the button 14a is pressed when the mouse is on the work surface, a bullet object 35 is fired and the remaining number of bullets decreases, and if the same button 14a is pressed when the mouse is not on the work surface, the remaining number of bullets may increase. In such a configuration, since the same button is used for firing and reloading of bullets, game operation can be made easy.

Also, the remaining number of bullets may be increased when, for example, the button 14b is pressed while the mouse 10 is being lifted. That is, if the button 14a is pressed when the mouse is on the work surface, a bullet object 35 is fired and the remaining number of bullets decreases, and if a button 14b different from the button 14a used for the firing instruction is pressed when the mouse is not on the work surface, the remaining number of bullets may increase. Note that when the button 14b is pressed when the mouse is on the work surface, nothing may happen, or some processing not involving increase or decrease of the number of bullets may be performed. Similarly, when the button 14a is pressed when the mouse is not on the work surface, nothing may happen, or some processing (which may be the same as or different from processing performed when the button 14b is pressed when the mouse is on the work surface) not involving increase or decrease of the number of bullets may be performed. In such a configuration, operations for firing and reloading of bullets can be separated.

Also, the predetermined operation performed together with the lifting operation of the mouse 10 is not limited to pressing of the button 14, and may be other operations. For example, as the predetermined operation, an operation of shaking the mouse 10 may be performed. For example, if the mouse 10 is lifted and data output from the inertial sensor 13 (the acceleration sensor and/or the angular velocity sensor) is a predetermined value indicating that the mouse 10 is being shaken, the remaining number of bullets may be increased. For example, when a lifting operation of the mouse 10 is detected and acceleration of the mouse 10 exceeds a threshold, the remaining number of bullets may be increased.

Also, the remaining number of bullets may be increased when an operation on the direction input unit 16 is performed together with the lifting operation of the mouse 10.

Also, the lifting operation of the mouse 10 and the predetermined operation may be performed at any timing. For example, the remaining number of bullets may be increased when the lifting operation of the mouse 10 and the predetermined operation are performed simultaneously. Also, the remaining number of bullets may be increased when a predetermined operation is performed in a predetermined period after the lifting operation of the mouse 10 has been performed. Also, the remaining number of bullets may be increased when the lifting operation of the mouse 10 is performed in a predetermined period after a predetermined operation has been performed.

Also, in the above, the remaining number of bullets is increased to the maximum value by one lifting operation. In another example embodiment, the number of bullets to be increased by one lifting operation may be predetermined. For example, one bullet may be increased by one lifting operation.

### Details of Game Processing

Next, details of game processing regarding the first game will be described. First, data used in the game processing will be described.

FIG. 9 is a diagram showing an example of various data used in game processing. As shown in FIG. 9, a game program, operation data, aiming object data, target object data, bullet object data, and bullet count data are stored in a memory (for example, the DRAM 22, the storage medium 23, etc.) of the game system 1.

The game program includes instructions for executing game processing. The game program is stored in the storage medium 23 in advance, and is read from the storage medium 23 and stored in the DRAM 22 when a game is executed.

Operation data is data regarding an operation performed on the mouse 10. The operation data is transmitted from the mouse 10 to the game apparatus 20 at predetermined time intervals (for example, 1/200 second intervals). The operation data transmitted from the mouse 10 is stored in the memory. Specifically, the operation data includes data regarding a movement direction and a movement amount calculated based on data from the mouse sensor 12. Note that when a position is calculated in addition to the movement direction and movement amount in the mouse 10, the operation data includes data regarding the calculated position. Also, when the mouse sensor 12 could not appropriately read an image of the work surface, the operation data includes data indicating that an image of the work surface could not be appropriately read. Also, the operation data includes data regarding movement and attitude of the mouse 10 calculated based on data from the inertial sensor 13. Also, the operation data includes data indicating whether or not the button 14 has been pressed and data regarding an operation on the direction input unit 16.

Aiming object data includes data regarding a position of the aiming object 31. Target object data includes data regarding a position, movement speed, and movement direction of the target object 33. Bullet object data includes data regarding a position, movement speed, and movement direction of a bullet object 35 fired into the virtual space. Bullet count data is data indicating the remaining number of bullets.

Note that, in addition to these, various data such as, for example, data regarding a user's points are stored in the memory.

### Game Processing

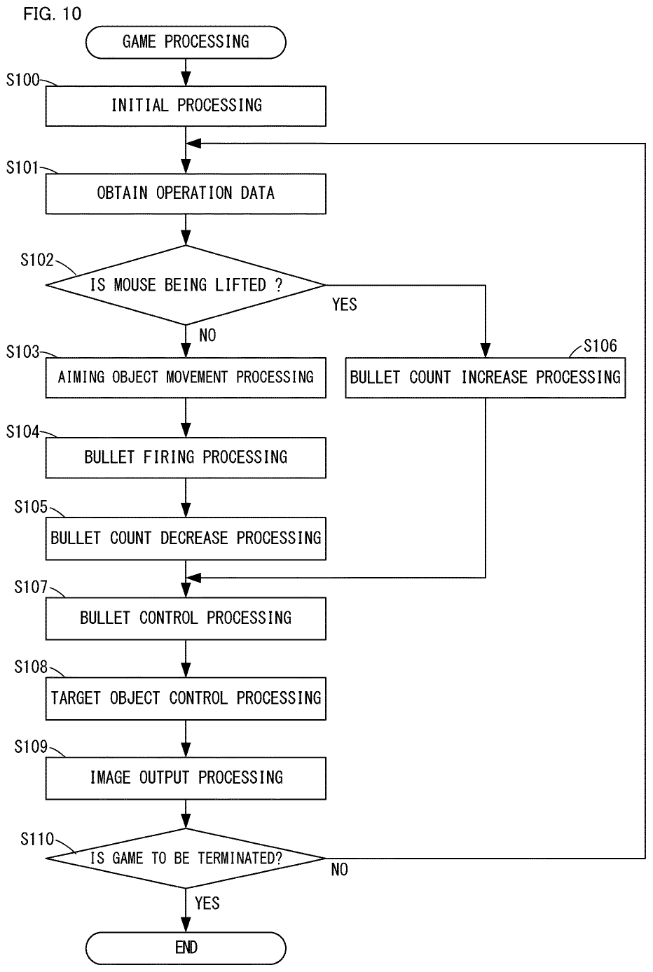

Next, game processing regarding the first game will be described. FIG. 10 is a flowchart showing an example of game processing regarding the first game.

In the following, description will be given assuming that the processor 21 of the game apparatus 20 executes processing of each step shown in FIG. 10 by executing the game program using the memory (for example, the DRAM 22). Note that a part of the processing of each step may be executed by a processor (for example, a dedicated circuit etc.) different from the processor 21. Also, when the game system 1 can communicate with another information processing apparatus (for example, a server), a part of the processing of each step may be executed in the another information processing apparatus.

As shown in FIG. 10, in step S100, the processor 21 executes initial processing. Specifically, the processor 21 arranges each object in the virtual space and sets a maximum value (for example, 4) in the bullet count data.

Next, the processor 21 obtains operation data (step S101). The game apparatus 20 repeatedly obtains operation data from the mouse 10 at predetermined time intervals (for example, 1/200 second intervals) and stores the operation data in the memory. In step S101, the processor 21 obtains the operation data stored in the memory. Hereafter, the processor 21 repeatedly executes processing of steps S102 to S110 at predetermined frame time intervals (for example, 1/60 second intervals).

Next, the processor 21 determines whether or not the mouse 10 is being lifted based on the operation data (step S102). For example, when the obtained operation data includes data indicating that an image of the work surface could not be appropriately read, the processor 21 determines that the mouse 10 is being lifted.

If it is not determined that the mouse 10 is being lifted (step S102: NO), the processor 21 performs aiming object movement processing based on the operation data (step S103).

Next, the processor 21 performs bullet firing processing (step S104). For example, the processor 21 fires a bullet object 35 based on the operation data. This firing of the bullet object 35 is an example of occurrence of an effect related to the aiming object 31.

Subsequently, the processor 21 performs bullet count decrease processing (step S105). Here, when a bullet object 35 has been fired in step S104, the processor 21 decreases the current remaining number of bullets by “1” and stores the number in the memory as bullet count data.

On the other hand, if it is determined that the mouse 10 is being lifted (step S102: YES), the processor 21 performs bullet count increase processing (step S106). For example, in the bullet count increase processing, the processor 21 determines whether or not a predetermined operation (for example, an operation of pressing the button 14a) has been performed on the mouse 10 based on the operation data. If it is determined that the predetermined operation has been performed, the processor 21 increases the remaining number of bullets and stores the number in the memory as bullet count data. Note that in the bullet count increase processing, it may be determined whether or not an operation of shaking the mouse 10 has been performed as the predetermined operation. Also, in the bullet count increase processing, whether or not a predetermined operation has been performed is not determined, and the remaining number of bullets may be increased.

When processing of step S105 or step S106 has been performed, the processor 21 performs bullet control processing (step S107). Here, the processor 21 updates the position of the bullet object 35 fired in step S104, or determines whether or not the bullet object 35 hit the target object 33. When the bullet object 35 hit the target object 33, the processor 21 adds a user's points.

Next, the processor 21 performs target object control processing (step S108). In the target object control processing, the processor 21 moves the target object 33 according to a predetermined algorithm.

Next, the processor 21 performs image output processing (step S109). For example, the processor 21 generates an image of the virtual space based on a virtual camera set behind the gun object 32, and displays the generated image on the display device.

Next, the processor 21 determines whether or not to terminate the game (step S110). For example, when termination of the game has been instructed by a user or when a predetermined time has elapsed from start of the game, the processor 21 determines to terminate the game. If it is determined not to terminate the game (step S110: NO), the processor 21 executes the processing of step S101 again.

Note that the processing of each step shown in FIG. 10 is merely an example, and if similar results can be obtained, the processing order of each step may be changed, or another processing may be executed in addition to (or instead of) the processing of each step. For example, if it is determined NO in step S102, it may be determined whether or not the mouse 10 is tilted, and if tilted, another processing C different from the processing of steps S103 to S105 (processing A) and the processing of step S106 (processing B) may be performed. That is, another processing C different from processing A and processing B may be performed based on data output when a part of the mouse 10 is in contact with the work surface 150 and the mouse 10 is tilted.

### Modifications

Although the first game of this example embodiment has been described above, the above example embodiment is merely an example, and for example, the following modifications may be added.

For example, in the above example embodiment, it is assumed that a shooting game is performed as a game using the mouse 10, but a second game different from a shooting game may be performed.

### Second Game

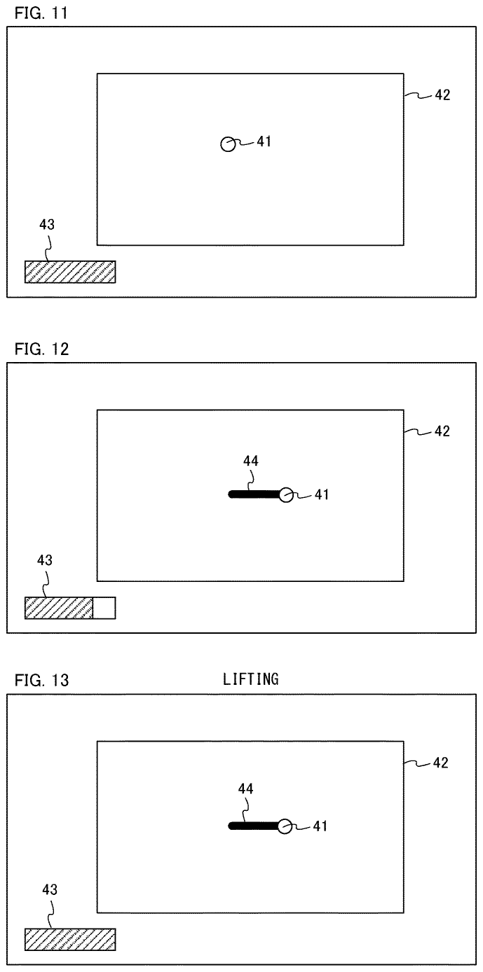

FIG. 11 is a diagram showing an example of a game image of a second game using the mouse 10. FIG. 12 is a diagram showing an example of a game image after the mouse 10 is moved on the work surface 150 from the state of FIG. 11. FIG. 13 is a diagram showing an example of a game image when the mouse 10 is lifted from the state of FIG. 12.

The second game is a game in which, by operations using the mouse 10, a picture is drawn or a color is painted on the virtual surface arranged in the virtual space, or something drawn on a virtual surface is erased.

As shown in FIG. 11, when the second game is started, an instruction object 41, a virtual surface 42, and an ink display 43 are displayed on the screen of the display device.

The instruction object 41 is an object for indicating a position using the mouse 10. The instruction object 41 may be, for example, an object imitating a pen, or may be an object imitating a spray. The instruction object 41 moves on the virtual surface 42 according to movement of the mouse 10 on the work surface 150. For example, when the mouse 10 is moved in the X-axis direction (a right direction when the mouse 10 is held in a normal holding way) on the work surface 150, the instruction object 41 also moves rightward on the virtual surface 42. The instruction object 41 moves by an amount according to the movement amount of the mouse 10 on the work surface 150.

Ease of ink output is set as a parameter related to the instruction object 41. The ease of ink output is indicated by the ink display 43. The longer a hatched part in the ink display 43 is, the more likely ink is to come out. The ink display 43 shown in FIG. 11 indicates that the ease of ink output is maximum.

For example, a user moves the mouse 10 on the work surface 150 while pressing the button 14a. Then, as shown in FIG. 12, the instruction object 41 moves and a line 44 is drawn on a movement path of the instruction object 41 on the virtual surface 42.

When the line 44 is drawn on the virtual surface 42, the ease of ink output decreases and it becomes difficult to draw the line 44. For example, the ease of ink output is decreased by an amount according to the length of the line 44 drawn by the instruction object 41 (or the area of a region on the virtual surface 42 painted with the line 44). When the ease of ink output becomes zero, the line 44 is not drawn even if the instruction object 41 moves. Note that when the ease of ink output decreases, the line 44 to be drawn may become thin, or the color of the line 44 may become light.

As shown in FIG. 13, when a lifting operation is performed on the mouse 10, the ease of ink output is increased. When the mouse 10 is lifted and a shaking operation is performed, the ease of ink output may be increased. At this time, predetermined feedback may be given to a user. For example, when a shaking operation of the mouse 10 is performed while the mouse 10 is being lifted, a predetermined sound may be output from a speaker, or a vibration motor provided in the mouse 10 may vibrate.

While the mouse 10 is being lifted, the instruction object 41 maintains the position immediately before the mouse 10 was lifted. When the mouse 10 is placed on the work surface 150 again and moved, the instruction object 41 moves from the position immediately before the mouse 10 was lifted.

In the second game, when the mouse 10 is moved on the work surface 150, even if a predetermined operation (pressing of the button 14 or an operation of shaking the mouse 10) is not performed, the line 44 may be drawn on the virtual surface and the ease of ink output may decrease. Also, when the mouse 10 is lifted, even if a predetermined operation is not performed, the ease of ink output may be increased. The ease of ink output may be something imitating an ink remaining amount. The ease of ink output may be non-displayed. That is, an internal parameter corresponding to the ease of ink output may be set.

### Third Game

Also, not limited to the first game and the second game, a third game may be performed using the mouse 10. For example, as the third game using the mouse 10, a game of wiping a window with a cloth may be performed. For example, a virtual window to which dirt is attached is arranged in the virtual space, and a cloth object is arranged at a predetermined position of the virtual window. A user moves the cloth object to a desired position by moving the mouse 10 on the work surface 150. When the button 14b is pressed, for example, while the mouse 10 is on the work surface 150, the cloth object is pressed against the virtual window. When the mouse 10 is moved on the work surface 150 in a state where the button 14b is pressed, the cloth object moves on the virtual window while being pressed against the virtual window. Thereby, dirt at a portion on the virtual window where the cloth object moved is removed. A degree of dirtiness is set for the cloth object, and for example, the degree of dirtiness of the cloth object increases by the amount of dirt removed from the virtual window. When the degree of dirtiness of the cloth object increases, even if the mouse 10 is moved on the work surface 150, dirt on the virtual window is not removed (or dirt on the virtual window spreads). When the mouse 10 is lifted and a predetermined operation (for example, pressing of the button 14b) is performed, the degree of dirtiness of the cloth object decreases. Thereby, dirt on the virtual window can be removed again. Such a degree of dirtiness of the cloth object can be regarded as a parameter indicating ease of removing dirt on the virtual window. The parameter decreases according to movement of the mouse 10 on the work surface 150 and increases by a lifting operation of the mouse 10.

Note that, in such a third game, even if there is no predetermined operation (for example, pressing of the button 14b), when the mouse 10 is moved on the work surface 150, dirt on the virtual window may be removed and the degree of dirtiness of the cloth object may increase. Also, when the mouse 10 is lifted, even if there is no predetermined operation (for example, pressing of the button 14b), the degree of dirtiness of the cloth object may decrease.

### Fourth Game

Also, as a fourth game using the mouse 10, a game in which a player character picks up objects falling in the virtual space may be performed. For example, by moving the mouse 10 on the work surface, the player character moves on the ground and picks up objects falling on the ground. The player character has a tank, and the tank has a predetermined capacity. The player character stores picked-up objects in the tank. During the game, the number or amount of objects stored in the tank is displayed. When the tank becomes full, the player character cannot store objects in the tank anymore. In such a game, when the mouse 10 is lifted, the tank becomes empty. Storing of objects in the tank by moving the mouse 10 on the work surface can be regarded as decreasing a remaining capacity of the tank. Also, emptying of the tank by lifting the mouse 10 can be regarded as increasing the remaining capacity of the tank.

Also, in addition to the games described above, an arbitrary game may be performed using the mouse 10. For example, as a game using the mouse 10, a game of moving a player character may be performed. By moving the mouse 10 on the work surface, the player character may be moved, physical strength of the player character may decrease according to the movement of the player character, and the physical strength of the player character may be recovered by lifting the mouse 10. For example, by moving the mouse 10 on the work surface, energy may be consumed while the player character moves, and energy may be recovered by lifting the mouse 10.

The mouse 10 may be configured to be usable in a mode like a game controller operated while being lifted by a user with one hand or both hands. Note that the mouse 10 may be configured to be able to switch ON/OFF of a mouse function. For example, when a user desires to operate the mouse 10 solely by lifting it without using it on a work surface, the mouse function may be configured to be able to be turned OFF. The mouse 10 may include, in addition to the mouse sensor 12, one or more push buttons for a user to perform game operations, one or more cross keys, one or more analog sticks, and an inertial sensor 13. The mouse 10 may be detachably connected to the game apparatus 20. In this case, the mouse 10 and the game apparatus 20 may be connected such that a surface in which the mouse sensor 12 (opening 104) is provided and a side surface of the game apparatus 20 face each other.

Also, the game described above may be performed using a plurality of mice including mouse sensors 12. One user may perform the game using a plurality of mice, or two users may each perform the game using a mouse. For example, a first user may move the aiming object 31 by moving a first mouse on a work surface, and a second user may move the target object 33 by moving a second mouse on the work surface.

As described above, a first process of moving a first object in a virtual space is performed based on first data output when the mouse 10 is on the work surface 150. Also, when the mouse 10 is on the work surface 150, a second process including occurrence of an action based on a position of the first object in the virtual space and a decrease in a parameter is performed. The first data may be, for example, data regarding a movement direction and a movement amount output when the mouse 10 moves on the work surface. Also, the first data may be data regarding a current position with respect to a certain reference position. The second process may be executed based on data output in response to the mouse 10 being moved on the work surface 150. Also, the second process may be executed based on data output in response to the mouse 10 being moved on the work surface 150 and a predetermined operation being performed on the mouse 10. The first object may be, for example, the aiming object 31 described above, may be the instruction object 41, may be the cloth object, may be the player character, or may be any other object. The occurrence of an action based on a position of the first object in the virtual space may be, for example, firing of a bullet object 35 toward the aiming object 31, or may be drawing of a line 44 according to movement of the instruction object 41. Also, the action based on the position of the first object in the virtual space may be that dirt on the virtual window is removed. Also, the action based on the position of the first object in the virtual space may be an action occurring due to movement of a player character, and may be, for example, that an object falling in the virtual space disappears. Also, the action based on the position of the first object in the virtual space is not limited to those described above and may be arbitrary. Also, the parameter may be anything as long as it decreases according to occurrence of an action regarding the first object. For example, the parameter may be the remaining number of bullets described above, may be the ease of ink output, may be the ease of dirt removal, may be the remaining capacity of the tank, or may be a physical strength value of the player character.

Also, a third process of increasing the parameter may be performed based on second data output when the mouse 10 is not on the work surface 150. The second data is data indicating that the mouse 10 is not on the work surface, and may be, for example, data indicating that the mouse sensor 12 cannot appropriately read an image of the work surface as described above, or may be data indicating the error.

Also, the second data may be based on data from the inertial sensor 13, not based on data from the mouse sensor 12. Movement and attitude of the mouse 10 are calculated based on data from the inertial sensor 13. When the mouse 10 is on the work surface 150, the mouse 10 may rotate around the Z-axis but does not rotate around the X-axis or the Y-axis. On the other hand, when the mouse 10 is not on the work surface 150, the mouse 10 may rotate around the X-axis or the Y-axis. For this reason, for example, when data indicating that the mouse 10 has rotated around the X-axis or the Y-axis is received as the second data, the game apparatus 20 may increase the parameter.

Also, the mouse 10 may include, for example, a sensor that measures a distance from the work surface 150 (for example, a distance measuring sensor), and the second data may be data from the distance measuring sensor. A height of the mouse 10 from the work surface 150 is calculated based on the second data from the distance measuring sensor, and it may be determined that the mouse 10 has been lifted when the calculated height exceeds a threshold.

Also, the parameter may be increased when a first operation (for example, pressing of the button 14) is performed on the mouse 10 in a case where the mouse 10 is being lifted from the work surface 150, and the parameter may be decreased when a second operation is performed on the mouse 10 in a case where the mouse 10 is on the work surface 150. The first operation and the second operation may be the same operation. In such a configuration, the parameter can be increased or decreased based on the same operation depending on whether or not the mouse 10 is on the work surface. Conversely, the first operation may be an operation different from the second operation. Also, the first operation may be an operation in which the inertial sensor outputs a predetermined value, and may be, for example, an operation of shaking the mouse 10.

Also, when the mouse 10 is placed on the work surface again and moved after the mouse 10 has been lifted from the work surface, the first object may be moved from a position where the mouse 10 was lifted from the work surface. That is, even if the mouse 10 is moved in a state being lifted from the work surface, the position of the first object may be configured not to change.

Note that the first object may move if, for example, a predetermined operation is performed on the mouse 10 in a state where the mouse 10 is being lifted from the work surface. For example, if the mouse 10 is shaken left and right in a state where the mouse 10 is being lifted from the work surface, the first object may swing left and right. Also, if an operation on the direction input unit 16 is performed in a state where the mouse 10 is being lifted from the work surface, the first object may move.

Also, in a case where the mouse 10 is on the work surface 150 and a predetermined operation (for example, pressing of a button, an operation on the direction input unit 16, an operation of shaking the mouse 10, etc.) is performed on the mouse 10, processing of decreasing the parameter is performed, and in a case where the mouse 10 is being lifted from the work surface 150 and a predetermined operation is performed, other processing not involving increase or decrease of the parameter may be performed. For example, when only the lifting operation of the mouse 10 is performed, increase processing of the parameter is performed, and when the second operation is performed together with the lifting operation of the mouse 10, increase or decrease of the parameter is not performed and another processing may be performed. The other processing may be, for example, processing of changing the type of weapon (gun object) equipped in a shooting game. Also, the other processing may be processing of controlling a second object different from the first object. In this way, different processes may be performed by the same operation depending on whether or not the mouse 10 is being lifted from the work surface 150.

Also, in a case where the mouse 10 is on the work surface and a predetermined operation is performed on the mouse 10, a first process may be performed, and in a case where the mouse 10 is being lifted and a predetermined operation is performed, a second process different from the first process may be performed.

Also, an operation different from the lifting operation of the mouse 10 described above, in which the mouse 10 is tilted with respect to the work surface 150 in a state where a part of the mouse 10 is in contact with the work surface 150 (here referred to as a “tilting operation”), may be performed. In this case, increase processing of the parameter may be performed by the lifting operation of the mouse 10, and another processing may be performed by the tilting operation of the mouse 10.

For example, whether or not the mouse 10 is on the work surface 150, whether or not a lifting operation has been performed, and whether or not a tilting operation has been performed can be determined based on an image obtained by the mouse sensor 12 and data from the inertial sensor 13. For example, if the mouse sensor 12 can appropriately read an image of the work surface (for example, if light intensity of the image exceeds a first value), it can be determined that the mouse 10 is on the work surface 150. Also, if the mouse sensor 12 cannot appropriately read an image of the work surface (for example, if light intensity is less than a second value), it can be determined that a lifting operation has been performed on the mouse 10. Also, if the mouse sensor 12 can read an image but the light intensity is in a predetermined range (for example, a range larger than the second value and smaller than the first value), and it is determined that the mouse 10 is rotating around the X-axis or the Y-axis based on data from the inertial sensor 13, it can be determined that a tilting operation has been performed on the mouse 10. Alternatively, when the mouse 10 includes a plurality of mouse sensors 12, if one mouse sensor 12 can appropriately read an image of the work surface and the other mouse sensor 12 cannot appropriately read an image of the work surface, it can be determined that a tilting operation has been performed on the mouse 10.

Also, a part or all of the processing performed by the game apparatus 20 described above may be configured to be performed by the mouse 10. Also, a part or all of the processing performed by the mouse 10 may be configured to be performed by the game apparatus 20. For example, the mouse 10 transmits an image from the mouse sensor 12 to the game apparatus 20, and the game apparatus 20 may calculate movement of the mouse 10 on the work surface 150 based on the image obtained from the mouse 10. Also, the game apparatus 20 may determine whether or not the mouse 10 has been lifted based on the obtained image. Also, the mouse 10 transmits data from the inertial sensor 13 to the game apparatus 20, and the game apparatus 20 may calculate movement and attitude of the mouse 10 based on the data. Then, the game apparatus 20 may determine whether or not the mouse 10 has been lifted based on the calculated movement and attitude.

Also, the game processing described above is not limited to the game system 1, and may be executed in any other information processing apparatus or information processing system. The information processing system may be configured by a plurality of apparatuses, and the plurality of apparatuses may be connected via a network (for example, a LAN, the Internet, etc.). Also, the processing described above may be distributed and executed by each of the plurality of apparatuses.

Also, configurations according to the above example embodiments and modifications thereof can be arbitrarily combined as long as they do not contradict each other. Also, the above is merely an illustration of the present embodiments, and various improvements and modifications other than the above may be added.

What is claimed is:

1. One or more non-transitory computer-readable storage media having stored therein instructions that, when executed, cause one or more processors to perform operations comprising:
moving a first object in a virtual space based on first data output in response to movement of a mouse on a work surface;
when the mouse is on the work surface, performing a second process including occurrence of an action based on a position of the first object in the virtual space and a decrease in a first parameter; and
performing a third process of increasing the first parameter based on second data output in response to the mouse being lifted from the work surface.

2. The one or more non-transitory computer-readable storage media according to claim 1, wherein in the third process, the first parameter is increased based on third data output in response to the mouse being lifted from the work surface and a first operation being performed on the mouse.

3. The one or more non-transitory computer-readable storage media according to claim 2, wherein in the second process, the first parameter is decreased based on fourth data output in response to the mouse being on the work surface and a second operation being performed on the mouse.

4. The one or more non-transitory computer-readable storage media according to claim 3, wherein the second operation is the same operation as the first operation.

5. The one or more non-transitory computer-readable storage media according to claim 2, wherein
the mouse includes an inertial sensor, and
the first operation is an operation in which the inertial sensor outputs a predetermined value.

6. The one or more non-transitory computer-readable storage media according to claim 5, wherein the predetermined value is a value indicating that the mouse is being shaken.

7. The one or more non-transitory computer-readable storage media according to claim 1, wherein when the mouse is returned onto the work surface and moved after the mouse has been lifted from the work surface, the first object is moved from a position where the mouse was lifted from the work surface.

8. The one or more non-transitory computer-readable storage media according to claim 1, wherein
in the second process, the first parameter is decreased based on fourth data output in response to the mouse being on the work surface and a second operation being performed on the mouse, and
the operations further comprise
performing a fourth process different from increase or decrease of the first parameter based on fifth data output in response to the mouse being lifted from the work surface and the second operation being performed.

9. The one or more non-transitory computer-readable storage media according to claim 1, wherein the operations further comprise:
performing a fifth process different from the second process based on sixth data output in response to the mouse being tilted while being partially in contact with the work surface.

10. A game system comprising one or more processors configured to perform operations comprising:
moving a first object in a virtual space based on first data output in response to movement of a mouse on a work surface;
when the mouse is on the work surface, performing a second process including occurrence of an action based on a position of the first object in the virtual space and a decrease in a first parameter; and
performing a third process of increasing the first parameter based on second data output in response to the mouse being lifted from the work surface.

11. The game system according to claim 10, wherein in the third process, the first parameter is increased based on third data output in response to the mouse being lifted from the work surface and a first operation being performed on the mouse.

12. The game system according to claim 11, wherein
the mouse includes an inertial sensor, and
the first operation is an operation in which the inertial sensor outputs a predetermined value.

13. The game system according to claim 10, wherein when the mouse is returned onto the work surface and moved after the mouse has been lifted from the work surface, the first object is moved from a position where the mouse was lifted from the work surface.

14. The game system according to claim 10, wherein
in the second process, the first parameter is decreased based on fourth data output in response to the mouse being on the work surface and a second operation being performed on the mouse, and
the operations further comprise
performing a fourth process different from increase or decrease of the first parameter based on fifth data output in response to the mouse being lifted from the work surface and the second operation being performed.

15. A computer-implemented method comprising:
moving a first object in a virtual space based on first data output in response to movement of a mouse on a work surface;
when the mouse is on the work surface, performing a second process including occurrence of an action based on a position of the first object in the virtual space and a decrease in a first parameter; and
performing a third process of increasing the first parameter based on second data output in response to the mouse being lifted from the work surface.

16. The method according to claim 15, wherein in the third process, the first parameter is increased based on third data output in response to the mouse being lifted from the work surface and a first operation being performed on the mouse.

17. The method according to claim 16, wherein
the mouse includes an inertial sensor, and
the first operation is an operation in which the inertial sensor outputs a predetermined value.

18. The method according to claim 15, wherein when the mouse is returned onto the work surface and moved after the mouse has been lifted from the work surface, the first object is moved from a position where the mouse was lifted from the work surface.

19. The method according to claim 15, wherein
in the second process, the first parameter is decreased based on fourth data output in response to the mouse being on the work surface and a second operation being performed on the mouse, and
the operations further comprise
performing a fourth process different from increase or decrease of the first parameter based on fifth data output in response to the mouse being lifted from the work surface and the second operation being performed.
